(19) United States
(12) Patent Application Publication
(10) Pub. No.: US 2013/0329564 A1
(43) Pub. Date: Dec. 12, 2013

(54) COMMUNICATION PATH CONTROL DEVICE, COMMUNICATION DEVICE, COMMUNICATION PATH CONTROL METHOD, COMMUNICATION METHOD, AND PROGRAM

(71) Applicant: Jun Nishioka, Tokyo (JP)

(72) Inventor: Jun Nishioka, Tokyo (JP)

(73) Assignee: NEC CORPORATION, Minato-ku, Tokyo (JP)

(21) Appl. No.: 14/001,224

(22) PCT Filed: Feb. 23, 2012
(86) PCT No.: PCT/JP2012/054423

§ 371 Date: Aug. 23, 2013

(30) Foreign Application Priority Data
Feb. 28, 2011 (JP) 2011-042964

(51) Int. Cl. H04L 1/20

(52) U.S. Cl. CPC H04L 1/20
USPC 370/241

(57) ABSTRACT

The problem of the present invention is, in a network configured from wireless links that can use an adaptive modulation function, when using 1+1 protection, to maintain communication without dropping of data occurring even if there is a drop in the transmission rate as a result of adaptive modulation. The invention of the present application having: an investigation means that, for every communication method that can be used in each of a normal pathway and a backup pathway, investigates an available band that is a band that can be allocated when the transmission rate of the normal pathway and the backup pathway has decreased; and a control means that, on the basis of the investigated available band and a band that a flow is requesting, sets marking in a manner so that the packets of the same flow in the normal pathway and the backup pathway can complement each other.

### TECHNICAL FIELD

The present invention relates to a path control in a mobile backhaul network, and particularly, to a network configured of wireless links having an adaptive modulation function.

### BACKGROUND ART

A demand for date communication traffics by data communication etc. has been increased with a recent progress in informatization. Thereupon, realization of a broadband and a reduction in an operation cost are required for a network. The network constructed by wireless links such as FWA (Fixed broadband wireless Access) using a wireless technique utilizing a frequency such as a milli-wave zone that enables transmission of the broadband is utilized for a mobile telephone net etc.

A communication quality of the wireless link fluctuates in SNR (Signal to Noise Ratio) of a received signal. Thereupon, so as to realize the broadband of the wireless link all the more, a pay has been attention to an adaptive modulation technology (for example, Patent literature 1). The adaptive modulation technology is a technology that adaptively finds a modulation technique having highest transmission efficiency from a wireless situation of the wireless link and uses it. The adaptive modulation technology enables optimal wireless communication responding to a wireless environment to be performed, and an enhancement in frequency efficiency to be expected.

Further, there exists the technology to be called 1+1 protection that causes identical data to flow in two paths, namely, a normal path and a backup path so as to enhance a reliability of a flow. The 1+1 protection makes it possible to enhance reliability of a flow even though a failure occurs in one path because the other path can be used to maintain the communication.

### CITATION LIST

### Patent Literature

PTL 1: JP-P2009-290547A

### SUMMARY OF INVENTION

### [Technical Problem]

Over the network configured of the wireless links of which the band fluctuates, if, when the 1+1 protection is carried out as it stands, a transmission rate declines in both paths due to an adaptive modulation function, a failure occurs in both paths, and resultantly, a drop of data occurs.

The problematic point is that even though the path is established by employing the 1+1 protection, the band the traffic needs cannot be secured when the transmission rate has declined in both paths, one part of the traffic is cancelled, and the above path becomes a path that does not satisfy the required communication quality.

Thereupon, the present invention has been accomplished in consideration of the above-mentioned problems, and an object of the present invention is to maintain communication without causing a drop of data to occur even though the transmission rate declines due to the adaptive modulation when the 1+1 protection is employed in the network configured of the wireless links that can utilize the adaptive modulation function.

### [Means For Solving Problems]

This claimed invention for solving the above-mentioned problems, which is a communication path control device, is characterized in including an investigation means that investigates an available band, being a band that can be assigned when transmission rates of a normal path and a backup path have declined, for each communication technique that can be used in each of the aforementioned normal path and the aforementioned backup path, and a control means that performs a marking setting in such a manner that packets of an identical flow can complement each other in the aforementioned normal path and the aforementioned backup path based on the aforementioned investigated available bands and a band that a flow is requesting.

This claimed invention for solving the above-mentioned problems, which is a communication device, is characterized in marking, according to marking information that has been set, based on available bands for each communication technique usable in each of a normal path and a backup path that are assigned when transmission rates of the aforementioned both paths have declined and a band that a flow is requesting, in such a manner that packets of an identical flow can complement each other in the aforementioned both paths, each packet of the aforementioned flow, and transferring the marked packets when the transmission rates of both of the normal path and the backup path decline.

This claimed invention for solving the above-mentioned problems, which is a communication path control method, is characterized in including an investigation step of investigating an available band, being a band that can be assigned when transmission rates of a normal path and a backup path have declined, for each communication technique that can be used in each of the aforementioned normal path and the aforementioned backup path, and a control step of performing a marking setting in such a manner that packets of an identical flow can complement each other in the aforementioned normal path and the aforementioned backup path based on the aforementioned investigated available bands and a band that a flow is requesting.

This claimed invention for solving the above-mentioned problems, which is a communication method, is characterized in marking, according to marking information that has been set, based on available bands for each communication technique usable in each of a normal path and a backup path that are assigned when transmission rates of the aforementioned both paths have declined and a band that a flow is requesting, in such a manner that packets of an identical flow can complement each other in the aforementioned both paths, each packet of the aforementioned flow, and transferring the marked packets when the transmission rates of both of the normal path and the backup path declines.

This claimed invention for solving the above-mentioned problems, which is a program of a communication path control device, is characterized in causing the aforementioned communication path control device to execute an investigation step of investigating an available band, being a band that can be assigned when transmission rates of a normal path and a backup path have declined, for each communication technique that can be used in each of the aforementioned normal path and the aforementioned backup path, and a control step of performing a marking setting in such a manner that packets of an identical flow can complement each other in the aforementioned normal path and the aforementioned backup path based on the aforementioned investigated available bands and a band that a flow is requesting.

This claimed invention for solving the above-mentioned problems, which is a program of a communication device, is characterized in causing the aforementioned communication device to execute a marking step of, according to marking information that has been set, based on available bands for each communication technique usable in each of a normal path and a backup path that are assigned when transmission rates of the aforementioned both paths have declined and a band that a flow is requesting, in such a manner that packets of an identical flow can complement each other in the aforementioned both paths, marking each packet of the aforementioned flow, and a transfer step of transferring the marked packets when the transmission rates of both of the normal path and the backup path decline.

### [Advantageous Effect Of Invention]

In accordance to the present invention, even though the transmission rates simultaneously decline in both of the normal path and the backup path, a drop of the data packets can be prevented and the originally secured communication of the band can be maintained as a whole of the path by transmitting the packets in such a manner that they complement each other in respective paths.

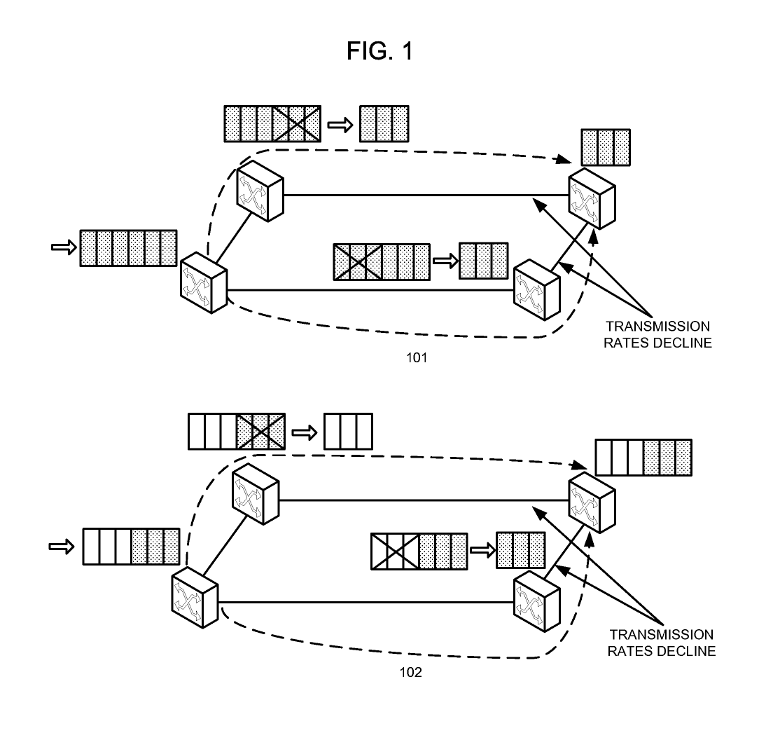

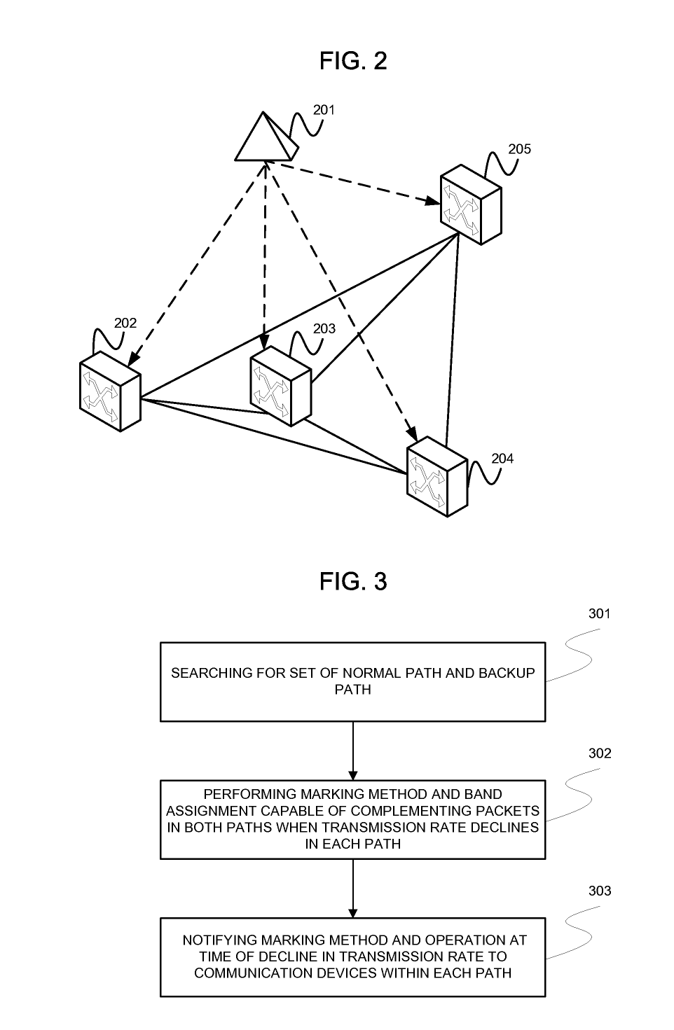

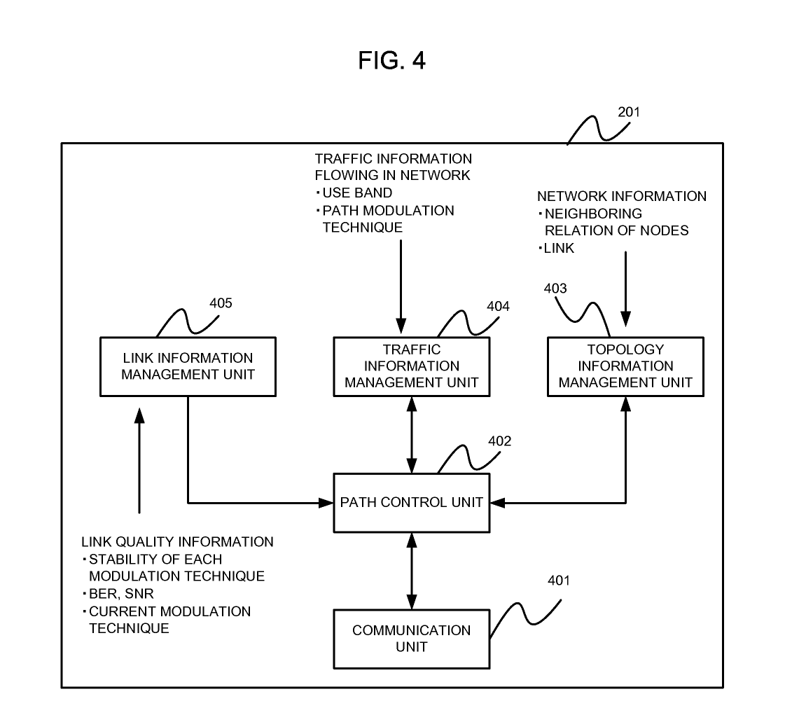

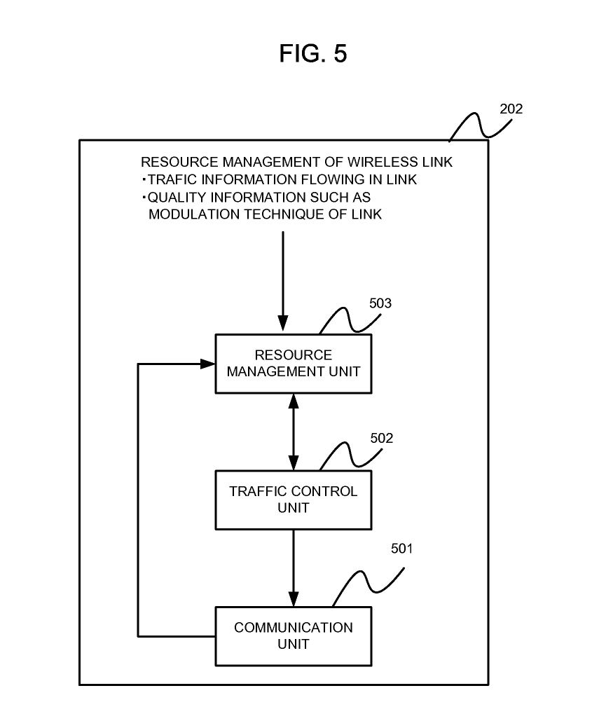

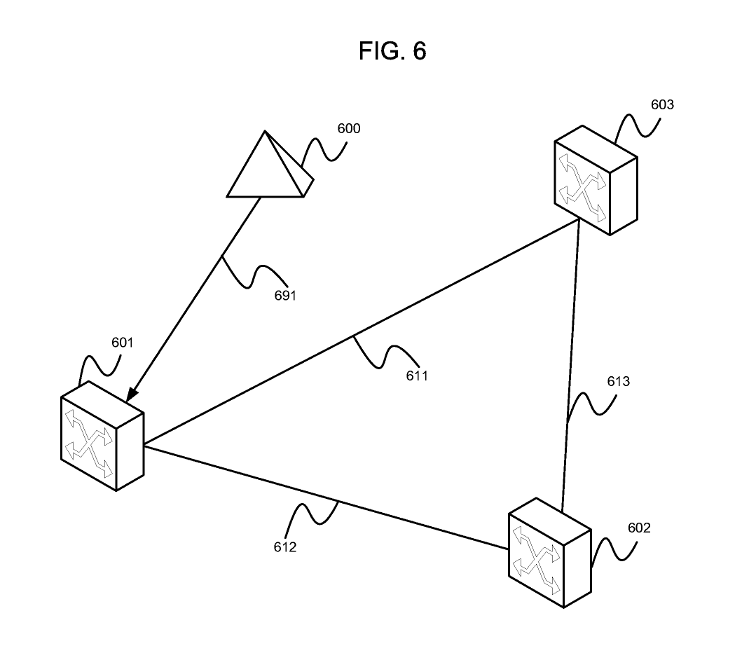

### BRIEF DESCRIPTION OF DRAWINGS

[FIG. 1] FIG. 1 is a view illustrating an effect of the present invention.

[FIG. 2] FIG. 2 is a view illustrating one configuration example of the network.

[FIG. 3] FIG. 3 is a flowchart illustrating a basic operational procedure of the path control device.

[FIG. 4] FIG. 4 is a block diagram illustrating one configuration example of the path control device.

[FIG. 5] FIG. 5 is a block diagram illustrating one configuration example of the communication device. [FIG. 6] FIG. 6 is a view illustrating one configuration example of the network in an example.

### DESCRIPTION OF EMBODIMENTS

So as to explain the present invention, the characteristics of the present invention are specifically mentioned by referencing the accompanied drawings.

This claimed invention utilizes the fact that a certain extent of the bandwidth can be secured in a situation of a decline in the transmission rate due to the adaptive modulation, differently from the link failure in a wire net. When a total of these remaining bandwidth is beyond a necessity, transferring pieces of data that complement each other in respective paths allows a drop of data to be prevented, thereby making it possible to maintain the communication quality.

The present invention will be mentioned by employing FIG. 1.

As shown in 101, with the case of not employing the present invention, when the transmission rates decline in the normal path and the backup path, a packet loss occurs in both paths. In particular, the identical packet is lost in the communication device in which the normal path and the backup path join together because the transmission path is not classified packet by packet, whereby a packet loss cannot be avoided even though the packets that have arrived from both paths are got together.

However, as shown in 102, with the case of employing the present invention, each packet is marked, and the packets each having a different marking are transferred also when the transmission rates decline in the normal path and the backup path. With this, even though a packet loss occurs in both paths, the packets each having a different marking arrive from respective paths, whereby a packet loss can be prevented by summing up the packets that have arrived.

The present invention is configured of a communication network system configured of a path control device 201 and communication devices 202 to 205 as shown in FIG. 2.

FIG. 3 is a flowchart for explaining an operation of the present invention.

The path control device 201 searches for the normal path and the backup path (301). Thereafter, the path control device 201 computes a dispersion method of the flows necessary for preventing a drop of data from the band that the flow can use in a case in which the transmission rate has declined in the link within each path (302). The path control device 201 performs a marking setting based on its result, and notifies its information to each communication device (303). Each of the communication devices 202 to 205 performs a transfer process based on the situation of its own wireless link and the notified information.

The path control device 201 performs a process of the notification from a service user to a network operator, for example of, a process of requesting for the establishment of the path of the flow and a process of terminating the flow, and therewith, acquires the link information from each communication device. The path control device 201, upon receipt of a request for establishing the path of the flow, searches for the path that can satisfy the band and the reliability, being a requirement of the flow. Herein, the path control device 201 searches for the normal path and the backup path that satisfy the requirement of the flow. Next, the path control device 201 investigates an extent in which the transmission rate declines in the wireless link constituting each path. This prediction is made based on the data periodically collected from the wireless link in terms of the quality. Herein, the path control device 201 computes, from the situation of the band assignment to the existing flow that already uses the identical wireless link, an extent in which the band that the flow can use declines in the identical wireless link when the transmission rate has declined. The path control device computes how the band that can be used in each path is changed based on a result thereof.

The path control device 201 performs a marking setting to the usable band so as to send pieces of the data that can complement each other in the normal path and the backup path to the communication device in which the path branches into the normal path and the backup path at the moment of establishing the paths, being the normal path and the backup path. Likewise, the path control device 201 notifies, to the communication device within each path, information as to which marked packets are transferred in a case in which the transmission rate declines in the wireless link that makes a connection to the above path control device.

An operation of each of the communication devices 202 to 205 after establishment is as follows.

The communication device in which the path branches into the normal path and the backup path marks the packets that are sent to the normal path and the backup path, based on the setting thereof. Further, each of the communication devices 202 to 205 sends the packets for which the specific marking has been performed based on a pre-designated setting when the transmission rate of the wireless link has declined. When the communication device in which the normal path and the backup path joint together detects a decline in the transmission rate in both paths, it reconstitute the packets coming from respective paths to the original flow based on the markings performed for the packets.

The action mentioned above makes it possible to prevent a drop of the data and to maintain the communication quality even though the transmission rate declines in both of the normal path and the backup path with the flow for which to the 1+1 protection has been performed.

The details of the present invention will be explained by employing FIG. 2.

The communication network system of the present invention is configured of the path control device 201 and each of the communication devices 202 to 205, being a subordinate. The path control device 201 manages an entirety of the network, and reception of the new flows, the finish thereof and the like are all performed by the path control device 201. The path control device 201 periodically acquires from each of the communication devices 202 to 205 a bit error rate of the wireless link, and link quality information relating to a link quality of the modulation technique etc. that are being used.

The path control device 201, as shown in FIG. 4, is configured of a communication unit 401, a path control unit 402, a topology information management unit 403, a traffic information management unit 404, and a link information management unit 405.

The topology information management unit 403 manages topology information.

The traffic information management unit 404 manages information of the flow that flows in the network.

The link information management unit 405 manages the link quality information acquired from each of the communication devices 202 to 205, the available bands, a list of the flows using the link, and information of each link such as the band that is assigned to the flow for each modulation technique.

The path control unit 402 processes a notification of a request for a new communication flow and the finish that is sent to the path control device 201, a notification of a change in the wireless link quality coming from each of the communication devices 202 to 205, and the like, acquires necessary information from the topology information management unit 403, the traffic information management unit 404, and the link information management unit 405, and performs the establishment of the path, the band assignment, and the like. The computation of the marking setting, being a characteristic of the present invention, and the like are performed by this path control unit 402. The link information management unit 405, upon receipt of the notification of a change in the link quality coming from each communication device via the path control unit 402, updates the link information.

Each of the communication devices 202 to 205, as shown in FIG. 5, is configured of a communication unit 501, a traffic control unit 502, and a resource management unit 503.

The traffic control unit 502 takes a band control and a path control for the flow using the link.

The resource management unit 503 manages information relating to the flow such as the bands assigned to the flow using the link, transfer destination, and the operations for each marking of the packet at the time of a fluctuation in the band.

Each of the communication devices 202 to 205 preserves the resource assignment information such as the assignment band to the each flow to be sent from the path control device, the transfer destination of each flow, and transfer processes for each marking in the resource management unit 503. And, the traffic control unit 502 takes a traffic control on the basis of the information preserved in the resource management unit 503. As the characteristics of the present invention, the traffic control unit 502 transfers only the packets for which the specific marking has been performed on the basis of the information of the resource management unit 503, and cancels the packets other than it when it detects a decline in the transmission rate.

Further, the resource management unit 503 monitors the communication unit 501, and when the resource management unit 503 detects a change in the link quality of the wireless link, it notifies the above information to the path control device.

Next, the details of an operation of the path control device 201 in the present invention will be explained by employing FIG. 3, FIG. 4, and FIG. 5. Additionally, the following operation is performed at the moment that the communication flow has newly occurred.

In the present invention, the path control device 201 searches for a communication path and a redundant path of the flow (301).

The path control device 201 predicts an extent in which a decline in the usable band due to a decline in the transmission rate occurs from the past statistics information in terms of these two paths, decides which marking is performed for the packet at the time when a decline in the transmission rate has occurred in each path, and computes which packet should be transferred by the communication device within each path at the time when a decline in the transmission rate has occurred in each path (302).

The path control device 201 notifies the setting of the marking for the packet to the communication device in which the path branches, and notifies the marking information of the packet that should be transferred to a decline in the transmission rate to the communication device within the path (303).

The detailed operation of each step is shown below.

The step of 301: The path control unit 402 searches for the normal path and the backup path of the flow from the topology information management unit 403, the traffic information management unit 404, and the link information management unit 405.

The step of 302: The path control unit 402 investigates the bands that the flow can use via the link information management unit 405 when a decline in the transmission rate has occurred in each of the normal path and the backup path. The path control unit 402 investigates how the flows should be dispersed in order to enable the communication to be maintained without dropping the data, based on a result thereof when the transmission rates have simultaneously declined in the normal path and the backup path, and decides the method of marking each packet of the flow.

The step of 303: The path control unit 402 notifies the marking for the packet to the communication device in which the path branches after establishing the normal path and the backup path. Further, the path control unit 402 notifies the transfer processes for each marking of the packets that are performed at the time of a decline in the transmission rate to the communication device within the path. Each communication device preserves the above information in the resource management unit 503.

An operation of each communication device after the establishment will be explained. Additionally, each of the communication devices performs a different operation responding to each role.

In the communication device in which the path branches into the normal path and the backup path, the traffic control unit 502 marks the packets at a pre-designated rate of the marking based on the information of the resource management unit 503.

In the communication device in which the normal path and the backup path joint together, the traffic control unit 502 re-structures the flow from the packets that arrive from respective paths based on the information of the resource management unit 503 when the transmission rates have declined in both paths. At this time, the traffic control unit 502 cancels the packets that have been marked in a duplicate manner, and re-structures the original flow from the packets that have been differently marked, respectively.

In all communication devices within the path, the communication unit 501 detects a decline in the transmission rate in the wireless link that the above communication device manages, the traffic control unit 502 transfers only the packets with the marking pre-designated for each of the above transmission rates on the basis of the information of the resource management unit 503, and cancels the packets other than them.

Next, one example of a method of deciding the marking for the flow that is performed in the step of 302 will be explained. While, for example, DSCP (Diff Serv Code Point) of an IP header of each packet is employed for the marking, it is assumed herein that the markings such as A, B, C, and D are performed for convenience. Further, it is assumed herein that the bands, which can be secured with each modulation technique of the wireless link, is assigned to each flow. The bands assigned for each modulation technique can be used so long as the wireless link does not employ a modulation technique lower than the above modulation technique.

At first, the available bands for each modulation technique are investigated in each wireless link constituting the path in terms of each of the normal path and the backup path previously searched for. Virtual links configured of the minimum available bands with each modulation technique are prepared for each of the normal path and the backup path.

It is temporarily assumed that a virtual link of the normal path is v1 and a virtual link of the backup path is v2, and it is assumed that the available bands with each modulation technique of the virtual link v1 and the virtual link v2 are

v1={b1, b2, . . . , bn}

v2={c1, c2, . . . , cp},

where, each of n and p is the number of the modulation techniques in which the available band remains. It is investigated whether the following conditions are satisfied for a band T that the flow needs, with an available band min_r with the modulation technique, being a minimum available band of both, as a reference.

min_{—}r=min({b1, . . . , bn}, {c1, . . . , cp})

m=min(n, p)

min_{—}r>=T/m

Where a minimum number min (n, p), out of the number n of the assignable modulation techniques of v1 and the number p of the assignable modulation techniques of v2, is employed for m.

When the above conditions are satisfied, a traffic T is divided for every T/m Mbps obtained by dividing T by m, and different markings, for example, A, B, C, and D are assigned thereto. Next, the bands with each modulation techniques are assigned for each marking.

In the wireless link to be employed in the normal path, the band corresponding to a traffic amount is assigned in order of the making A, the marking B, the marking C, and the marking D, to begin with a lowest modulation technique. In the wireless link to be employed in the backup path, the bands with each modulation technique are assigned in an order opposite hereto. If the bands with the low modulation techniques are assigned in an order of the marking A, the marking B, the marking C, and the marking D in the normal path, respectively, to begin with the band with a lowest modulation technique, the bands with the low modulation techniques are assigned contrarily, namely in an order of the marking D, the marking C, the marking B, and the marking A in the backup path, to begin with the band with a lowest modulation technique.

On the other hand, when

min_{—}r*m<T

is yielded, and the conditions are not satisfied, the marking setting and the assignment of the bands with each modulation technique are firstly performed for only a portion of min_r*m, as mentioned previously. The virtual links v1 and v2 are prepared again by employing the available bands for each modulation technique of each link. The assignment is performed for a flow T′ to which the band has not been assigned by employing the band with the modulation technique in which the available band still remains.

T′=T−min_{—}r*m

The available bands of the virtual links v1 and v2 become, respectively,

v1={b1′, . . . bg′}

v2={c1′, . . . ch′}.

Similarly to the previous case, the minimum available band min_r′ and the number m′ of the modulation techniques are obtained again from among the modulation techniques in which the available band still remains.

min_{—}r′=min({b1′, . . . , bg′}, {c1′, . . . ch′})

m′=min(g, h)

And, the assignment of the marking and the assignment of the bands mentioned above are decided for the remaining traffic T′. At this time, the symbols other than the symbols previously used are employed for the marking setting in such a manner that, for example, when A to D were previously used, the marking setting is performed, to begin with E.

The assignment above is repeated until the marking and the band assignment is performed for all traffics. Additionally, in the above-mentioned explanation, the modulation techniques in which the available band remained was employed; however, the modulation technique to be employed may be limited only to the modulation techniques in which a certain constant available band or more remains.

### EXAMPLE 1

The example of the present invention will be explained by employing a schematic view of the network system of FIG. 6.

The network system is configured of a path control device 600, a wireless link 691 connecting the path control device 600 and a communication device 601, a wireless link 611 connecting the communication device 601 and a communication device 603, a wireless link 612 connecting the communication device 601 and a communication device 602, and a wireless link 613 connecting the communication device 602 and the communication device 603.

Further, it is assumed that the wireless links 611, 612, and 613 can use the modulation techniques of QPSK, 16QAM, 32QAM, and 128QAM, respectively. It is assumed that the bands with each modulation technique are 40 Mbps, 80 Mbps, 108 Mbps, and 155 Mbps, respectively. In this case, the band that can be assigned in each modulation technique becomes

{QPSK, 16QAM, 32QAM, 128QAM}32 {40, 40, 28, 55}.

Herein, in this network, the path is established between the communication devices 601 and 603 by employing the 1+1 protection with a flow of 40 Mbps. It is assumed that the path control device 600 has found the normal path 601-603 employing the wireless link 611 and the backup path 601-602-603 employing the wireless link 612 and the wireless link 613 as a result of searching for the paths. It is assumed that the band already assigned to the existing flow exists and the available bands for each modulation technique of each wireless link are

Wireless link 611: {QPSK, 16QAM, 32QAM, 128QAM}={30, 30, 28, 30}

Wireless link 612: {QPSK, 16QAM, 32QAM, 128QAM}={30, 40, 28, 40}

Wireless link 613: {QPSK, 16QAM, 32QAM, 128QAM}={40, 20, 28, 40}

,
respectively.
Then, the virtual link v1 of the normal path 601-603 and the virtual link v2 of the backup path 601-602-603 become

V1: {QPSK, 16QAM, 32QAM, 128QAM}={30, 30, 28, 30}

V2: {QPSK, 16QAM, 32QAM, 128QAM}={30, 20, 28, 40},

respectively, and the minimum available band min_r and the number m of the modulation techniques become

min_r=20

m=min(4,4)=4,

respectively.

Herein, T=40 because the band that the flow uses is 40 Mbps and 20>40/4 because the number of the modulation techniques in which the available band exists is m=4. From this, min_r>=T/m holds.

Thereupon, it is decided that the flow is divided for every 40/4=10 Mbps, and the markings of A, B, C, and D are assigned hereto, respectively.

And, in the wireless link 611 constituting the normal path 601-603, the band with QPSK is assigned for the packet for which the marking of A has been performed, the band with 16QAM is assigned for the packet for which the marking of B has been performed, the band with 32QAM is assigned for the packet for which the marking of C has been performed, and the band with 128QAM is assigned for the packet for which the marking of D has been performed, by 10 Mbps, respectively.

And, for the wireless links 612 and 613 constituting the backup path 601-602-603, the band with QPSK is assigned for the packet for which the marking of D has been performed, the band with 16QAM is assigned for the packet for which the marking of C has been performed, the band with 32QAM is assigned for the packet for which the marking of B has been performed, and the band with 128QAM is assigned for the packet for which the marking of A has been performed, by 10 Mbps, respectively. These marking information and band assignment information are notified to each of the communication devices 601, 602, and 603 within the path from the path control device 600.

The markings such as A, B, C, and D are performed in the communication device 601 in which the path branches into the normal path and the backup path. Each communication device controls the packets that are transferred responding to the modulation technique of the wireless link. In this example, with the case in which the modulation technique is 128QAM in each wireless link, all packets are transferred in both of the normal path and the backup path.

In each wireless link of the normal path, the packets for which the markings of A, B, and C have been performed, respectively, are transferred with the case in which the modulation technique is 32QAM, the packets for which the markings of A and B have been performed is transferred with the case in which the modulation technique is 16QAM, and the packet for which the markings of A has been performed is transferred with the case in which the modulation technique is QPSK. In each wireless link of the backup path, contrary hereto, the packets for which the markings of D, C, and B have been performed, respectively, are transferred with the case in which the modulation technique is 32QAM, the packets for which the markings of D and C have been performed, respectively, are transferred with the case in which the modulation technique is 16QAM, and only the packet for which the marking of D has been performed is transferred with the case in which the modulation technique is QPSK.

As mentioned above, a packet loss can be prevented because when the modulation technique is 32QAM in the wireless link 611 to be used in the normal path, and the modulation technique is QPSK in the wireless link 612 or the wireless link 613 constituting the backup path, the packets A to D arrive the communication device 603 in which the paths joint together. Further, a packet loss can be prevented because when, contrarily hereto, the modulation technique is QPSK in the wireless link 611, and the modulation technique is 32QAM in the wireless link 612 or the wireless link 613, the packets A to D arrive the communication device 603 in which the paths joint together also in a case in which the modulation technique has become 16QAM in the wireless links constituting both paths.

### EXAMPLE 2

An example in a case of accommodating the flow of 64 Mbps that furthermore uses the similar normal path 601-603 and backup path 601-602-603 after the operation in the example 1 has been performed will be explained.

The available bands with each modulation technique of the virtual links v1 and v2 become, as described below,

V1: {QPSK, 16QAM, 32QAM, 128QAM}={20, 20, 18, 20}

V2: {QPSK, 16QAM, 32QAM, 128QAM}={20, 10, 18, 30},

respectively.
Where 64/4=16 is yielded with min_r=10, T=64, and m=4, whereby min_r<T /m is resultantly yielded.

Thereupon, at first, the flow is divided into min_r*m=40 Mbps and 64−40=24 Mbps. The markings of A, B, C, and D are assigned by 10 Mbps, respectively.

In the wireless link 611 constituting the normal path 601-603, the band with QPSK is assigned for the packet for which the marking of A has been performed, the band with 16QAM is assigned for the packet for which the marking of B has been performed, the band with 32QAM is assigned for the packet for which the marking of C has been performed, and the band with 128QAM is assigned for the packet for which the marking of D has been performed, by 10 Mbps, respectively.

In the wireless links 612 and 613 constituting the backup path 601-602-603, the band with QPSK is assigned for the packet for which the marking of D has been performed, the band with 16QAM is assigned for the packet for which the marking of C has been performed, the band with 32QAM is assigned for the packet for which the marking of B has been performed, and the band with 128QAM is assigned for the packet for which the marking of A has been performed, by 10 Mbps, respectively.

As a result, the available bands with each modulation technique of the virtual links v1 and v2 become

V1: {QPSK, 16QAM, 32QAM, 128QAM}={10, 10, 8, 10}

V2: {QPSK, 16QAM, 32QAM, 128QAM}={10, 0, 8, 20},

respectively,
the number of the modulation techniques in which the number of the available bands is equal to or more than zero is m′=min(4, 3)=3, 8=24/3 is yielded from the minimum available band min_r′=8 Mbps, out of them, and hence, min_r′>=T′/m holds, whereby T′=24 Mbps is divided into 8*3.

Similarly to the previous case, the marking and the band assignment for every remaining 8 Mbps are decided. Herein, E, F, and G are employed next to D as the marking.

In the wireless link 611 constituting the normal path 601-603, the band with QPSK is assigned for the packet for which the marking of E has been performed, the band with 16QAM is assigned for the packet for which the marking of F has been performed, and the band with 128QAM is assigned for the packet for which the marking of G has been performed by 8 Mbps, respectively.

In the wireless links 612 and 613 constituting the backup path 601-602-603, the band with QPSK is assigned for the packet for which the marking of G has been performed, the band with 32QAM is assigned for the packet for which the marking of F has been performed, and the band with 128QAM is assigned for the packet for which the marking of E has been performed by 8 Mbps, respectively.

The path control device 600 notifies a result of the marking assignment and the band assignment mentioned above to the each of the communication devices 601, 602, and 603. Any of the markings of A to G is performed for each packet of the flow in the communication device 601 in which the path branches.

When the modulation technique is lower than 128QAM in the wireless link 611 constituting the normal path 601-603, only packets for which the specific marking has been performed are transferred. The packets for which the markings of A, B, C, E, and F have been performed, respectively, are transferred with the case in which the modulation technique is 32QAM, the packets for which the markings of A, B, E, and F have been performed, respectively, are transferred with the case in which the modulation technique is 16QAM, and the packets for which the markings of A and E have been performed, respectively, are transferred with the case in which the modulation technique is QPSK.

On the other hand, in the wireless links 612 and 613 constituting the backup path 601-602-603, the packets for which the markings of D, C, B, F, and G have been performed, respectively, are transferred with the case in which the modulation technique is 32QAM, the packets for which the markings of D, C, and G have been performed, respectively, are transferred with the case in which the modulation technique is 16QAM, and only the packets for which the markings of D and G have been performed, respectively, are transferred with the case in which the modulation technique is QPSK.

With this, a packet loss can be prevented because when the modulation technique of the wireless link 611 to be used in the normal path is 32QAM, and the modulation technique of one of the wireless link 612 and the wireless link 613 constituting the backup path is QPSK, the packets of A to G arrive the communication device 603 also in a case in which the modulation technique has become 16QAM in the wireless link constituting both of the paths. Further, a packet loss can be prevented because when, contrarily hereto, when the modulation technique of the wireless link 611 is QPSK, and the modulation technique of one of the wireless link 612 and the wireless link 613 is 32QAM, the packets of A to G arrive the communication device 603 also in a case in which the modulation technique of the wireless link constituting both of the paths has become 16QAM.

When the modulation technique of the wireless link to be used in the normal path is 32QAM, and the modulation technique of o the wireless link to be used in the backup path is 16QAM, and the like, the packets, one part of which have been marked in a duplicate manner, result in arriving the communication device 603 from both paths; however the communication device 603 cancels the packets that have been marked in a duplicate manner, thereby enabling a recovery to the original flow.

Additionally, the present invention can be also realized with a configuration in which the communication device has a function of the path control device. In the case of such a configuration, each component unit of the above-mentioned path control device constitutes the communication device.

Further, the present invention can be realized similarly not only with the 1+1 protection but also with the 1+N protection. In addition, the present invention can be similarly realized not only with a path protection, being a protection of an entirety of the path, but also with a segment protection, being a protection for one part of the path.

Further, the present invention can be similarly realized in a case of employing a backup multicast tree also in the one-to-N type communication such as a multicast.

In addition, each device of the present invention mentioned above, as apparent from the above-mentioned explanation, can be configured with hardware; however, it can be also realized with a computer program.

Functions and operations similar to the functions and the operations of the above-described exemplary embodiment are realized by a processor that operates under a program stored in a program memory. Additionally, only one part of the above-described functions of the exemplary embodiment can be realized with the computer program.

Above, while the present invention has been particularly shown and described with reference to preferred exemplary embodiment and example, the present invention is not limited to the above mentioned exemplary embodiment and example. It will be understood by those of ordinary skill in the art that various changes in form and details may be made therein without departing from the spirit and scope of the present invention.

This application is based upon and claims the benefit of priority from Japanese patent application No. 2011-042964, filed on Feb. 28, 2011, the disclosure of which is incorporated herein in its entirety by reference.

(Supplementary Note 1)

A communication path control device, including:

an investigation means that investigates an available band, being a band that can be assigned when transmission rates of a normal path and a backup path have declined, for each communication technique that can be used in each of the aforementioned normal path and the aforementioned backup path; and

a control means that performs a marking setting in such a manner that packets of an identical flow can complement each other in the aforementioned normal path and the aforementioned backup path based on the aforementioned investigated available bands and a band that a flow is requesting.

(Supplementary Note 2)

The communication path control device according to the supplement note 1, wherein the aforementioned control means changes a method of the marking and a method of assigning the band to each modulation technique responding to a result of comparing a value of a minimum available band of the aforementioned investigated available bands with a value obtained by dividing the band that the aforementioned flow is requesting by the number of the modulation techniques in which the available band exists.

(Supplementary Note 3)

The communication path control device according to the supplement note 1 or the supplement note 2, wherein the aforementioned control means assigns the band to each modulation technique by the value obtained by dividing the bandwidth that the aforementioned flow is requesting by the number of the modulation techniques in which the available band exists when the value of the minimum available band of the aforementioned investigated available bands is larger than the value obtained by dividing the band that the aforementioned flow is requesting by the number of the modulation techniques in which the available band exists, and performs a marking for each modulation technique.

(Supplementary Note 4)

The communication path control device according to the supplement note 1 or the supplement note 2,wherein the aforementioned control means assigns the band to each modulation technique by the minimum available band of the aforementioned available bands investigated for each modulation technique when the value of the minimum available band of the aforementioned investigated available bands is smaller than the value obtained by dividing the bandwidth that the aforementioned flow is requesting by the number of the modulation techniques in which the available band exists, and furthermore assigns the band to each modulation technique by the minimum available band of the aforementioned available bands investigated for each modulation technique in terms of a portion that does not reach the band that the flow is requesting.

(Supplementary Note 5)

A communication device:

marking, according to marking information that has been set, based on available bands for each communication technique usable in each of a normal path and a backup path that are assigned when transmission rates of the aforementioned both paths have declined and a band that a flow is requesting, in such a manner that packets of an identical flow can complement each other in the aforementioned both paths, each packet of the aforementioned flow; and

transferring the marked packets when the transmission rates of both of the normal path and the backup path decline.

(Supplementary Note 6)

The communication device according to the supplement note 5, restructuring, after receiving the aforementioned marked packets of the identical flow from the aforementioned normal path and the aforementioned backup path, the packets of the aforementioned identical flow in such a manner that they are not repeated.

(Supplementary Note 7)

A communication path control method, including: an investigation step of investigating an available band, being a band that can be assigned when transmission rates of a normal path and a backup path have declined, for each communication technique that can be used in each of the aforementioned normal path and the aforementioned backup path; and

a control step of performing a marking setting in such a manner that packets of an identical flow can complement each other in the aforementioned normal path and the aforementioned backup path based on the aforementioned investigated available bands and a band that a flow is requesting.

(Supplementary Note 8)

The communication path control method according to the supplement note 7, wherein the aforementioned control step changes a method of the marking and a method of assigning the band to each modulation technique responding to a result of comparing a value of a minimum available band of the aforementioned investigated available bands with a value obtained by dividing the band that the aforementioned flow is requesting by the number of the modulation techniques in which the available band exists.

(Supplementary Note 9)

The communication path control method according to the supplement note 7 or the supplement note 8, wherein the aforementioned control step assigns the band to each modulation technique by the value obtained by dividing the bandwidth that the aforementioned flow is requesting by the number of the modulation techniques in which the available band exists when the value of the minimum available band of the aforementioned investigated available bands is larger than the value obtained by dividing the band that the aforementioned flow is requesting by the number of the modulation techniques in which the available band exists, and performs a marking for each modulation technique.

(Supplementary Note 10)

The communication path control method according to the supplement note 7 or the supplement note 8, wherein the aforementioned control step assigns the band to each modulation technique by the minimum available band of the aforementioned available bands investigated for each modulation technique when the value of the minimum available band of the aforementioned investigated available bands is smaller than the value obtained by dividing the bandwidth that the aforementioned flow is requesting by the number of the modulation techniques in which the available band exists, and furthermore assigns the band to each modulation technique by the minimum available band of the aforementioned available bands investigated for each modulation technique in terms of a portion that does not reach the band that the flow is requesting.

(Supplementary Note 11)

A communication method, including:

marking, according to marking information that has been set, based on available bands for each communication technique usable in each of a normal path and a backup path that are assigned when transmission rates of the aforementioned both paths have declined and a band that a flow is requesting, in such a manner that packets of an identical flow can complement each other in the aforementioned both paths, each packet of the aforementioned flow: and

transferring the marked packets when the transmission rates of both of the normal path and the backup path decline.

(Supplementary Note 12)

The communication method according to the supplement note 11, including restructuring, after receiving the aforementioned marked packets of the identical flow from the aforementioned normal path and the aforementioned backup path, the packets of the aforementioned identical flow in such a manner that they are not repeated.

(Supplementary Note 13)

A program of a communication path control device, causing the aforementioned communication path control device to execute:

an investigation step of investigating an available band, being a band that can be assigned when transmission rates of a normal path and a backup path have declined, for each communication technique that can be used in each of the aforementioned normal path and the aforementioned backup path; and

a control step of performing a marking setting in such a manner that packets of an identical flow can complement each other in the aforementioned normal path and the aforementioned backup path based on the aforementioned investigated available bands and a band that a flow is requesting.

(Supplementary Note 14)

A program of a communication device, causing the aforementioned communication device to execute:

a marking step of, according to marking information that has been set, based on available bands for each communication technique usable in each of a normal path and a backup path that are assigned when transmission rates of the aforementioned both paths have declined and a band that a flow is requesting, in such a manner that packets of an identical flow can complement each other in the aforementioned both paths, marking each packet of the aforementioned flow: and

a transfer step of transferring the marked packets when the transmission rates of both of the normal path and the backup path decline.

### REFERENCE SIGNS LIST

201 path control device

202 communication device

203 communication device

204 communication device

205 communication device

401 communication unit

402 path control unit

403 topology information management unit

404 traffic information management unit

405 link information management unit

501 communication unit

502 a traffic control unit

503 resource management unit

600 path control device

601 communication device

602 communication device

603 communication device

611 wireless link

612 wireless link

613 wireless link

What is claimed is:

1. A communication path control device, comprising:
an investigation means that investigates an available band, being a band that can be assigned when transmission rates of a normal path and a backup path have declined, for each communication technique that can be used in each of said normal path and said backup path; and
a control means that performs a marking setting in such a manner that packets of an identical flow can complement each other in said normal path and said backup path based on said investigated available bands and a band that a flow is requesting.

2. The communication path control device according to claim 1, wherein said control means changes a method of the marking and a method of assigning the band to each modulation technique responding to a result of comparing a value of a minimum available band of said investigated available bands with a value obtained by dividing the band that said flow is requesting by the number of the modulation techniques in which the available band exists.

3. The communication path control device according to claim 1, wherein said control means assigns the band to each modulation technique by the value obtained by dividing the band that said flow is requesting by the number of the modulation techniques in which the available band exists when the value of the minimum available band of said investigated available bands is larger than the value obtained by dividing the bandwidth that said flow is requesting by the number of the modulation techniques in which the available band exists, and performs a marking for each modulation technique.

4. The communication path control device according to claim 1, wherein said control means assigns the band to each modulation technique by the minimum available band of said available bands investigated for each modulation technique when the value of the minimum available band of said investigated available bands is smaller than the value obtained by dividing the bandwidth that said flow is requesting by the number of the modulation techniques in which the available band exists, and furthermore assigns the band to each modulation technique by the minimum available band of said available bands investigated for each modulation technique in terms of a portion that does not reach the band that the flow is requesting.

5. A communication device:
marking, according to marking information that has been set, based on available bands for each communication technique that are assigned when transmission rates of both of a normal path and a backup path have declined, said communication technique being able to be used in each of said both paths, and a band that a flow is requesting, in such a manner that packets of an identical flow can complement each other in said both paths, each packet of said flow; and
transferring the marked packets when the transmission rates of both of the normal path and the backup path decline.

6. The communication device according to claim 5, restructuring, after receiving said marked packets of the identical flow from said normal path and said backup path, said packets of said identical flow in such a manner that they are not repeated.

7. A communication path control method, comprising:
an investigation step of investigating an available band, being a band that can be assigned when transmission rates of a normal path and a backup path have declined, for each communication technique that can be used in each of said normal path and said backup path; and
a control step of performing a marking setting in such a manner that packets of an identical flow can complement each other in said normal path and said backup path based on said investigated available bands and a band that a flow is requesting.

8. A communication method, comprising:
marking, according to marking information that has been set, based on available bands for each communication technique that are assigned when transmission rates of both of a normal path and a backup path have declined, said communication technique being able to be used in each of said both paths, and a band that a flow is requesting, in such a manner that packets of an identical flow can complement each other in said both paths, each packet of said flow; and
transferring the marked packets when the transmission rates of both of the normal path and the backup path decline.

9. A program of a communication path control device, causing said communication path control device to execute:
an investigation step of investigating an available band, being a band that can be assigned when transmission rates of a normal path and a backup path have declined, for each communication technique that can be used in each of said normal path and said backup path; and
a control step of performing a marking setting in such a manner that packets of an identical flow can complement each other in said normal path and said backup path based on said investigated available bands and a band that a flow is requesting.

10. A computer readable media comprising program of a communication device, causing said communication device to execute:
a marking step of, according to marking information that has been set, based on available bands for each communication technique that are assigned when transmission rates of both paths of a normal path and a backup path have declined, said communication technique being able to be used in each of said both paths and, a band that a flow is requesting, in such a manner that packets of an identical flow can complement each other in said both paths, marking each packet of said flow; and
a transfer step of transferring the marked packets when the transmission rates of both of the normal path and the backup path decline.
